(19) United States
(12) Patent Application Publication
(10) Pub. No.: US 2026/0264663 A1
(43) Pub. Date: Sep. 10, 2026

(54) HYBRID ELECTRIC VEHICLE

(71) Applicant: TOYOTA JIDOSHA KABUSHIKI KAISHA, Toyota-shi (JP)

(72) Inventors: Taku HARADA, Nisshin-shi (JP); Yohei AGATSUMA, Nagoya-shi (JP); Manabu UEHARA, Miyoshi-shi (JP); Yuya AOKI, Miyoshi-shi (JP); Masaki HIRONAKA, Gamagori-shi (JP)

(73) Assignee: TOYOTA JIDOSHA KABUSHIKI KAISHA, Toyota-shi (JP)

(21) Appl. No.: 19/448,380

(22) Filed: Jan. 14, 2026

(30) Foreign Application Priority Data
Mar. 5, 2025 (JP) 2025-034964

(51) Int. Cl. B60W 20/13; B60W 10/06; B60W 10/08; B60W 20/40

(52) U.S. Cl. CPC B60W 20/13; B60W 10/06; B60W 10/08; B60W 20/40; B60W 2510/244

(57) ABSTRACT

A control device of a hybrid electric vehicle executes: monitoring a remaining amount of energy of a battery while electric power of the battery is being supplied to an external device via an external power supply connector; and starting charging of the battery by driving an internal combustion engine in a drive mode set to cause a generator to generate electricity, in accordance with a result of the monitoring indicating that the remaining amount of the energy of the battery has reached a lower limit amount. The control device selects one mode from among the modes and sets the selected mode as a drive mode of the internal combustion engine. The modes include a first mode and a second mode, and the second mode is defined such that an output of the internal combustion engine when the internal combustion engine is driven is higher than in the first mode.

### CROSS-REFERENCE TO RELATED APPLICATION

This application claims priority to Japanese Patent Application No. 2025-034964 filed on March 5, 2025. The disclosure of the above-identified application, including the specification, drawings, and claims, is incorporated by reference herein in its entirety.

### BACKGROUND

### 1. Technical Field

The present disclosure relates to a hybrid electric vehicle.

### 2. Description of Related Art

Japanese Unexamined Patent Application Publication No. 2019-162896 (JP 2019-162896 A) proposes a hybrid electric vehicle configured such that, when the remaining amount of energy of a battery is equal to or greater than a predetermined amount, electric power of a battery can be supplied to an external device.

### SUMMARY

An object of the present disclosure is to provide a technique for charging a battery during external power supply, in which it is possible to switch between prioritizing quietness and prioritizing power supply efficiency.

A hybrid electric vehicle according to a first aspect of the present disclosure includes an internal combustion engine, a generator, a battery, an external power supply connector, and a control device. The generator is configured to generate electricity using power from the internal combustion engine. The battery is connected to the generator via an electric power line. The external power supply connector is configured to supply electric power of the battery to an external device to be connected. The control device is configured to execute: monitoring a remaining amount of energy of the battery while the electric power of the battery is being supplied to the external device via the external power supply connector; and starting charging of the battery by driving the internal combustion engine in a drive mode that is set to cause the generator to generate the electricity, in response to the remaining amount of the energy of the battery reaching a lower limit amount as a result of the monitoring. The control device is configured to further execute: selecting one mode from among a plurality of modes; and setting the mode that is selected as the drive mode of the internal combustion engine. The modes include a first mode and a second mode. The second mode is defined such that an output of the internal combustion engine when the internal combustion engine is driven is higher than an output of the internal combustion engine in the first mode.

According to the present disclosure, it is possible to execute the external power supply by switching between prioritizing quietness and prioritizing power supply efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example configuration of a hybrid electric vehicle;

FIG. 2 schematically illustrates an example of driving conditions of the internal combustion engine in each mode;

FIG. 3 schematically illustrates an example of a relationship between driving of the internal combustion engine and a remaining amount of energy of the battery in each mode;

FIG. 4 schematically illustrates an example of a relationship between driving of the internal combustion engine and a remaining amount of energy of the battery in each mode;

FIG. 5 is a flowchart illustrating an example of a processing procedure related to mode setting by the control device; and

FIG. 6 is a flowchart illustrating an example of a processing procedure related to the external power supply by the control device.

### DETAILED DESCRIPTION OF EMBODIMENTS

In recent years, a hybrid electric vehicle including an internal combustion engine (an engine or the like) and a battery has been commercially available. The hybrid electric vehicle is configured to supply the electric power of the battery to an external device. Supplying the electric power of the battery to the external device is also referred to as "external power supply". When the remaining amount of energy of the battery decreases, the hybrid electric vehicle may no longer secure a sufficient driving range. Therefore, the hybrid electric vehicle is configured such that, when the remaining amount of energy of the battery reaches a lower limit amount, the internal combustion engine is driven to allow the external power supply to be executed while charging the battery. However, when the internal combustion engine is driven to charge the battery, reducing the output of the internal combustion engine can secure the quietness, but the power supply efficiency deteriorates. On the other hand, when the output of the internal combustion engine is increased, the power supply efficiency can be improved, but the quietness deteriorates.

In contrast, the hybrid electric vehicle according to the first aspect of the present disclosure includes an internal combustion engine, a generator, a battery, an external power supply connector, and a control device. The generator is configured to generate electricity using power from the internal combustion engine. The battery is connected to the generator via an electric power line. The external power supply connector is configured to supply electric power of the battery to an external device to be connected. The control device is configured to execute monitoring a remaining amount of energy of the battery while the electric power of the battery is being supplied to the external device via the external power supply connector. Further, the control device is configured to execute starting charging of the battery by driving the internal combustion engine in a drive mode that is set to cause the generator to generate the electricity, in accordance with a result of the monitoring indicating that the remaining amount of energy of the battery has reached the lower limit amount. The control device is configured to further execute: selecting one mode from among a plurality of modes; and setting the mode that is selected as a drive mode of the internal combustion engine. The modes include a first mode and a second mode. The second mode is defined such that an output of the internal combustion engine when the internal combustion engine is driven is higher than an output of the internal combustion engine in the first mode.

In the first aspect of the present disclosure, at least two or more modes including the first mode and the second mode are prepared as the drive mode of the internal combustion engine when the battery is charged. The second mode is defined such that an output of the internal combustion engine when the internal combustion engine is driven is higher than in the first mode. As a result, in the second mode, the quietness deteriorates as compared with the first mode, but the power supply efficiency can be improved. On the other hand, in the first mode, the power supply efficiency deteriorates as compared with the second mode, but the quietness can be secured. Therefore, according to the first aspect of the present disclosure, by switching the drive mode between the first mode and the second mode, it is possible to charge the battery during the external power supply by switching between prioritizing quietness and prioritizing power supply efficiency.

As another embodiment of the hybrid electric vehicle according to the above aspect, one aspect of the present disclosure may be a control device mounted on the hybrid electric vehicle. Further, one aspect of the present disclosure may be an information processing method executed by the control device, a program, or a storage medium readable by a machine, such as a computer, that stores such a program. Here, the storage medium readable by a machine refers to a medium that stores information such as a program by electrical, magnetic, optical, mechanical, or chemical means.

### Configuration Example

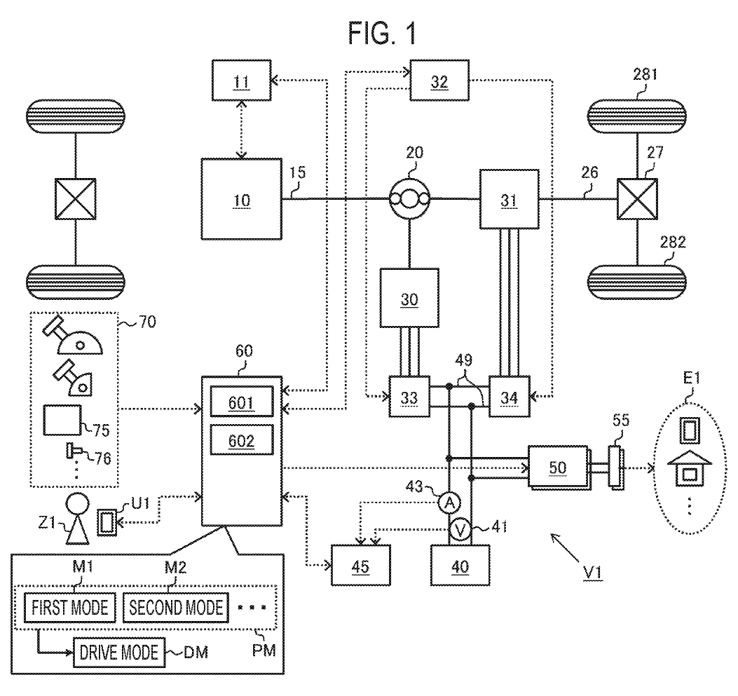

FIG. 1 schematically illustrates an example of a configuration of the hybrid electric vehicle V1 according to the present embodiment. The hybrid electric vehicle V1 according to the present embodiment includes an engine 10, a motor 30, a battery 40, an external power supply connector 55, and a control device 60.

### Engine Peripherals

The engine 10 is an example of an internal combustion engine. The type of the engine 10 (internal combustion engine) may not be particularly limited and may be selected as appropriate according to the embodiment. In one example, the engine 10 may be configured as an internal combustion engine that outputs power as a fuel such as gasoline, diesel, or hydrogen. In one example, the hybrid electric vehicle V1 may further include a control unit 11 for the engine 10, and the operation of the engine 10 may be controlled by the control unit 11.

The configuration of the control unit 11 may be optionally determined. In one example, the control unit 11 may include an ECU (Electronic Control Unit) including a processor, a memory, an input/output port, a communication port, and the like. The control unit 11 may receive an input of various types of information (a signal of a sensor or the like) used for controlling the engine 10 via an input port. The various types of information may include, for example, a crank angle of a crankshaft 15 of the engine 10, a throttle opening degree in a throttle valve, a temperature of the coolant of the engine 10, and a remaining amount of fuel in a fuel tank. The crank angle may be measured by a crank position sensor that detects a rotational position of the crankshaft 15. The throttle opening degree may be measured by a throttle valve position sensor that detects a position of the throttle valve. The temperature of the coolant may be measured by a water temperature sensor. The remaining amount of the fuel may be measured by a fuel sensor provided in the fuel tank. The control unit 11 may output a control signal for controlling the operation of the engine 10 via an output port. The output control signal may include, for example, a control signal to a throttle motor that adjusts the position of the throttle valve, a control signal to a fuel injection valve, and a control signal to an ignition coil. In addition, the control unit 11 may be connected to the control device 60 via a network through a communication port. The type of the network may be optionally selected. The network may be, for example, a controller area network (CAN). The control unit 11 may be configured to control the operation of the engine 10 in accordance with the control signal from the control device 60. The control unit 11 may be configured to output data related to the operating state of the engine 10 to the control device 60. In one example, the control unit 11 may calculate the rotational speed of the crankshaft 15, that is, the rotational speed of the engine 10 based on the crank angle measured by the crank position sensor. As a result, the control unit 11 may control the operation of the engine 10 while monitoring the rotational speed of the engine 10 as a control amount.

### Motor Peripherals

In one example, the hybrid electric vehicle V1 may further include a planetary gear 20 and a motor 31. The planetary gear 20 may be configured as a single-pinion type planetary gear mechanism. A sun gear of the planetary gear 20 may be connected to a rotor of the motor 30. A drive shaft 26 may be connected to a ring gear of the planetary gear 20. A pair of drive wheels (281, 282) may be connected to the drive shaft 26 via a differential device 27. The crankshaft 15 of the engine 10 may be connected to a carrier of the planetary gear 20. As a result, the hybrid electric vehicle V1 may be configured to obtain a drive force by outputting the power of the engine 10 to the drive wheels (281, 282).

In one example, the motor 30 may be configured as a synchronous generator motor. The motor 30 is an example of a generator. The configuration of the generator may be optionally modified. In one example of the present embodiment, the power of the engine 10 can be transmitted to the motor 30 via the planetary gear 20. The motor 30 is configured to generate electricity using the power transmitted from the engine 10. The motor 31 may be configured as a synchronous generator motor. The rotor of the motor 31 may be connected to the drive shaft 26. The hybrid electric vehicle V1 may further include inverters (33, 34) corresponding to the respective motors (30, 31). Each of the inverters (33, 34) may be connected to an electric power line 49 together with the battery 40. In one example, the hybrid electric vehicle V1 may further include a control unit 32 for each of the motors (30, 31). The switching device of each of the inverters (33, 34) may be switching-controlled by the control unit 32, so that each of the motors (30, 31) may be rotationally driven.

The configuration of the control unit 32 may be optionally determined. In one example, the control unit 32 may include an ECU including a processor, a memory, an input/output port, a communication port, and the like, as in the control unit 11. The control unit 32 may receive an input of various types of information (a signal of a sensor or the like) used for controlling each of the motors (30, 31) via an input port. The various types of information may include, for example, a rotational position of each of the motors (30, 31) and a phase current of each of the motors (30, 31). The rotational position (rotational speed) may be measured by an encoder (a sensor that detects the rotational position of the rotor) provided in each of the motors (30, 31). The phase current may be derived from a measurement value of a current sensor that measures a current flowing in each phase of each of the motors (30, 31). The control unit 32 may output a control signal for controlling the operation of each of the motors (30, 31) via an output port. The control signal to be output may include, for example, a switching control signal to a switching element of each of the inverters (33, 34). In addition, the control unit 32 may be connected to the control device 60 via a network through a communication port, as in the control unit 11. The control unit 32 may be configured to control the operation of each of the motors (30, 31) in accordance with the control signal from the control device 60. The control unit 32 may be configured to output data related to the operating state of each of the motors (30, 31) to the control device 60. In one example, the control unit 32 may calculate the rotational speed of each of the motors (30, 31) based on the rotational position of the rotor of each of the motors (30, 31), the rotational position being measured by each encoder. As a result, the control unit 32 may control the operation of each of the motors (30, 31) while monitoring the rotational speed of each of the motors (30, 31) as a control amount.

### Battery Peripherals

The type of the battery 40 may not be particularly limited and may be selected as appropriate according to the embodiment. In one example, the battery 40 may include a secondary battery such as a lithium-ion secondary battery or a nickel-metal hydride secondary battery. The battery 40 may be connected to the electric power line 49 together with each of the inverters (33, 34). As a result, the battery 40 may be connected to the motor 30 (generator) via the electric power line 49. With the battery 40 connected to the motor 30, the hybrid electric vehicle V1 may be configured to charge the battery 40 with electric power generated by the motor 30 as driven by the engine 10. In addition, the battery 40 may be connected to the motor 31 via the electric power line 49. With the battery 40 connected to the motor 31, the hybrid electric vehicle V1 may be configured to obtain a drive force by driving the motor 31 with the electric power of the battery 40. In one example, the hybrid electric vehicle V1 may further include a control unit 45 for the battery 40, and the state of the battery 40 may be managed by the control unit 45.

The configuration of the control unit 45 may be optionally determined. In one example, the control unit 45 may include an ECU including a processor, a memory, an input/output port, a communication port, and the like, as in the control unit 11 and the like. The control unit 45 may receive an input of various types of information (a signal of a sensor or the like) used for managing the battery 40 via an input port. The various types of information may include, for example, a voltage of the battery 40, a current at an output terminal of the battery 40, and a temperature of the battery 40. The voltage of the battery 40 may be measured by a voltage sensor 41 installed between terminals of the battery 40. The current at the output terminal may be measured by a current sensor 43 installed at the output terminal of the battery 40. The temperature of the battery 40 may be measured by a temperature sensor attached to the battery 40. In addition, the control unit 45 may be connected to the control device 60 via a network through a communication port, as in the control unit 11 and the like. The control unit 45 may be configured to output data related to the state of the battery 40 to the control device 60. In one example, the control unit 45 may calculate the remaining amount of energy based on an integrated value of the current measured by the current sensor 43. The remaining amount of energy may be a capacity of the electric power that can be discharged from the battery 40 with respect to a total capacity of the battery 40. The remaining amount of energy may be calculated as a state of charge (SOC). The method of calculating the remaining amount of energy may not be limited to such an example and may be modified as appropriate according to the embodiment. In addition, the control unit 45 may calculate the input/output limit based on the calculated remaining amount of energy and the temperature measured by the temperature sensor. The input limit is a maximum allowable electric power when the battery 40 is charged, and the output limit is a maximum allowable electric power when the battery 40 is discharged. The value of the input/output limit may be optionally determined by any method. For example, the input/output limit of the battery 40 may be calculated by (1) setting a basic value of the input/output limit based on the temperature of the battery 40, (2) setting a correction coefficient based on the remaining amount of energy of the battery 40, and (3) integrating the correction coefficient with the basic value. In one example, the output limit of the battery 40 may be set to be smaller as the temperature of the battery 40 deviates from the allowable temperature range toward a higher side or a lower side, and to be lower as the remaining amount of energy of the battery 40 is smaller. The input limit of the battery 40 may be set to be larger (smaller in absolute value) as the temperature of the battery 40 deviates from the allowable temperature range toward a higher side or a lower side, and to be larger (smaller in absolute value) as the remaining amount of energy of the battery 40 is higher.

### External Power Supply Connector

The external power supply connector 55 may be connected to the electric power line 49 via the charge/discharge device 50. The external device E1 may be connected to the external power supply connector 55. As a result, the external power supply connector 55 according to the present embodiment is configured to supply the electric power of the electric power line 49 (at least one of the electric power of the battery 40 and the electric power generated by the motor 30 as driven by the engine 10) to the connected external device E1. The type of the external power supply connector 55 and the method of connecting to the external device E1 may not be particularly limited and may be selected as appropriate according to the embodiment. In one example, the external power supply connector 55 may include a socket that directly accepts a connection of a plug of the external device E1. In another example, the external power supply connector 55 may be configured to accept a connection of a dedicated attachment such as a vehicle power connector and to be indirectly connected to the external device E1 via the attachment. The electric power output from the external power supply connector 55 may be either direct current or alternating current. In one example, the charge/discharge device 50 may be configured to convert the direct current electric power of the electric power line 49 into alternating current electric power by including an inverter and to supply the obtained alternating current electric power to the external device E1 connected to the external power supply connector 55. The charge/discharge device 50 may be replaced with an inverter. The charge/discharge device 50 may be configured to supply the direct current electric power of the electric power line 49 to the external device E1. The operation of the charge/discharge device 50 may be controlled by the control device 60. Supplying the electric power of the electric power line 49 to the external device E1 may be referred to as "external power supply".

In addition, the number of the external power supply connectors 55 may be optionally determined. In one example, the hybrid electric vehicle V1 may include a plurality of external power supply connectors 55. Each of the external power supply connectors 55 may be connected to the electric power line 49 via the charge/discharge device 50. When the hybrid electric vehicle V1 includes the external power supply connectors 55, the type of each of the external power supply connectors 55 and the method of connecting to the external device E1 may be the same or may differ at least partially.

The type of the external device E1 may not be particularly limited and may be selected as appropriate according to the embodiment. The external device E1 may include, for example, an electric product such as a mobile terminal or a notebook personal computer (PC). The mobile terminal may include a smartphone, a tablet terminal, and the like. The external device E1 may include facilities such as a house. The external power supply connector 55 may be configured to be connectable to a charging facility. Alternatively, the hybrid electric vehicle V1 may further include another connector connected to the electric power line via the charge/discharge device, and the other connector may be configured to be connected to the charging facility. As a result, the hybrid electric vehicle V1 may be configured to charge the battery 40 with the electric power from the connected charging facility.

### Control Device

The configuration of the control device 60 may be optionally determined. In one example, the control device 60 may include an ECU including a processor 601, a memory 602, an input/output port, a communication port, and the like, as in the control unit 11 and the like. The type of the processor 601 may be optionally selected. For example, the processor 601 may include a central processing unit (CPU). For example, the processor 601 may include a microprocessor, a field-programmable gate array (FPGA), or an application specific integrated circuit (ASIC). The type of the memory 602 may be optionally selected. For example, the memory 602 may include RAM, ROM, or a semiconductor memory. The memory 602 may store various types of information such as a control program. The control program may include various commands for controlling the operation of the hybrid electric vehicle V1.

The control device 60 may receive an input of various types of information (a signal of a sensor, data from another control unit, or the like) used for controlling the hybrid electric vehicle V1 via the input port. The various types of information may include a signal of an operation device 70, operation information of the operation device 70, or the like. The operation information of the operation device 70 may be obtained by a sensor. For example, the operation device 70 may include an ignition switch, and the various types of information may include an ignition signal. The operation device 70 may include a shift lever, and the various types of information may include an operation position (shift position) of the shift lever. The operation position of the shift lever may be measured by a shift position sensor. The operation device 70 may include an accelerator pedal, and the various types of information may include a depression amount (accelerator operation amount) of the accelerator pedal. The accelerator operation amount may be measured by an accelerator pedal position sensor. The operation device 70 may include a brake pedal, and the various types of information may include a depression amount (brake pedal position) of the brake pedal. The brake pedal position may be measured by a brake pedal position sensor. In addition, the various types of information may include the electric power supplied during the external power supply from the external power supply connector 55, a vehicle speed of the hybrid electric vehicle V1, or the like. The supplied electric power may be measured by an electric power sensor. The vehicle speed of the hybrid electric vehicle V1 may be measured by a vehicle speed sensor. The control device 60 may output a control signal to the charge/discharge device 50 via the output port. The control device 60 may be connected to each of the control units (11, 32, 45) via the communication port. As a result, the control device 60 may receive various types of data from each of the control units (11, 32, 45). The control device 60 may output a control signal to each of the control units (11, 32, 45).

In addition, the operation device 70 may include an input device. That is, the control device 60 may be connected to the input device. The various types of information may include an operation (input) of the input device. The type of the input device may be optionally selected. The input device may include, for example, a touch panel 75, an operator 76, or a microphone. In addition, the control device 60 may be connected to an output device. The type of the output device may be optionally selected. The output device may include, for example, a display, or a speaker. The control device 60 may output any information to the output device. The control device 60 may be connected to the input device and the output device by any method. In one example, the control device 60 may be directly connected to the input device and the output device via the input/output port. In another example, the control device 60 may be indirectly connected to the input device and the output device through a communication port via a device such as a control unit (ECU or the like).

The control device 60 may control the operation of the hybrid electric vehicle V1 as appropriate. In one example, when the hybrid electric vehicle V1 is being driven and the operation position of the shift lever is a drive position (D position) or a reverse position (R position), the control device 60 may set a drive force to be requested to the drive shaft 26. The control device 60 may set the drive force to be requested to the drive shaft 26 based on the accelerator operation amount and the vehicle speed. Then, the control device 60 may control the operation of the engine 10 and each of the motors (30, 31) such that the power corresponding to the set drive force is output to the drive shaft 26. The power output to the drive shaft 26 may be obtained from at least one of the engine 10 and the battery 40. A known method such as JP 2019-162896 A may be adopted for the operation control during the driving.

### Control Device/Execution of External Power Supply

In addition, the control device 60 may be configured to execute the external power supply from the battery 40 to the external device E1 in response to the establishment of a predetermined operating condition. The operating conditions may be optionally set. In one example, the operating conditions may be that the external device E1 is connected to the external power supply connector 55, the operation position of the shift lever is a parking position (P position), and an instruction to execute the external power supply has been provided. The instruction to execute the external power supply may be optionally provided. For example, the instruction to execute the external power supply may be provided in response to the switching on of a switch for the external power supply in the input device by the user. The switch for the external power supply may be either a software switch (the touch panel 75 or the like) and a physical switch (the operator 76 or the like).

### Control Device/Start of Battery Charging

In the present embodiment, the control device 60 executes monitoring a remaining amount of energy of the battery 40 while the electric power of the battery 40 is being supplied to the external device E1 by the external power supply connector 55. Further, the control device 60 executes starting charging of the battery 40 by driving the engine 10, in the drive mode DM that is set to cause the motor 30 to generate the electricity, in accordance with a result of the monitoring indicating that the remaining amount of energy of the battery 40 has reached the lower limit amount. The method of monitoring the remaining amount of energy may not be particularly limited and may be selected as appropriate according to the embodiment. In one example, the control unit 45 may calculate the remaining amount of energy of the battery 40 and transmit data indicating the calculated remaining amount of energy (calculation result) to the control device 60. The control device 60 may monitor the remaining amount of energy of the battery 40 by receiving the data. A timing at which the remaining amount of energy is monitored may be optionally determined. The control unit 45 may repeatedly execute the calculation of the remaining amount of energy of the battery 40 and the transmission of the calculation result to the control device 60. As a result, the control device 60 may continuously monitor the remaining amount of energy of the battery 40 via the control unit 45. The control device 60 may determine whether the remaining amount of energy of the battery 40 has reached the lower limit amount in accordance with the result of the monitoring. The lower limit amount is a threshold value that serves as a criterion for starting charging of the battery 40 by driving the engine 10. The lower limit amount (lower limit threshold value) may be optionally defined. When the acquired remaining amount of energy exceeds the lower limit amount, the control device 60 may determine that the remaining amount of energy has not reached the lower limit amount. On the other hand, when the acquired remaining amount of energy is less than the lower limit amount, the control device 60 may determine that the remaining amount of energy has reached the lower limit amount. When the acquired remaining amount of energy is equal to the lower limit amount, the control device 60 may determine that the remaining amount of energy has reached the lower limit amount or may determine that the remaining amount of energy has not reached the lower limit amount. The control device 60 may start charging of the battery 40 by driving the engine 10 by providing the control signal to each of the control units (11, 32) in response to the determination that the remaining amount of energy of the battery 40 has reached the lower limit amount. A part of the electric power generated by the motor 30 as driven by the engine 10 may be supplied to the external device E1 or may not be supplied to the external device E1. In addition, the external power supply mode in which the electric power of the battery 40 is automatically replenished by driving the engine 10 may be referred to as an HV power supply mode. In addition, the hybrid electric vehicle V1 may be configured to execute an operation of an EV power supply mode in which the engine 10 is not driven and solely the electric power of the battery 40 is used for the external power supply.

### Control Device/Drive Mode

In the present embodiment, a plurality of modes PM is prepared as the modes that can be set as the drive mode DM. Each of the modes PM defines driving conditions (drive amount, torque, rotational speed, and the like) of the engine 10 when the battery 40 is charged. The control device 60 is configured to further execute: selecting one mode from among the modes PM; and setting the mode that is selected as a drive mode DM of the engine 10. The drive mode DM is the mode that is selected as the mode to be used for driving the engine 10 (internal combustion engine) when the battery 40 is charged, from among the modes PM. The control device 60 may determine the control command to be provided to each of the control units (11, 32) in accordance with the driving conditions defined in the drive mode DM that is set.

In addition, in the present embodiment, the modes PM include a first mode M1 and a second mode M2. The second mode M2 is defined such that the output of the engine 10 when the engine 10 is driven is higher than in the first mode M1. In at least one of the first mode M1 and the second mode M2, the output of the engine 10 may be directly defined or may be indirectly defined via torque or the like. The output of the engine 10 may be defined as appropriate in relation to the drive force applied to the motor 30. In one example, the output of the engine 10 may be defined by at least one of the rotational speed and the torque of the engine 10.

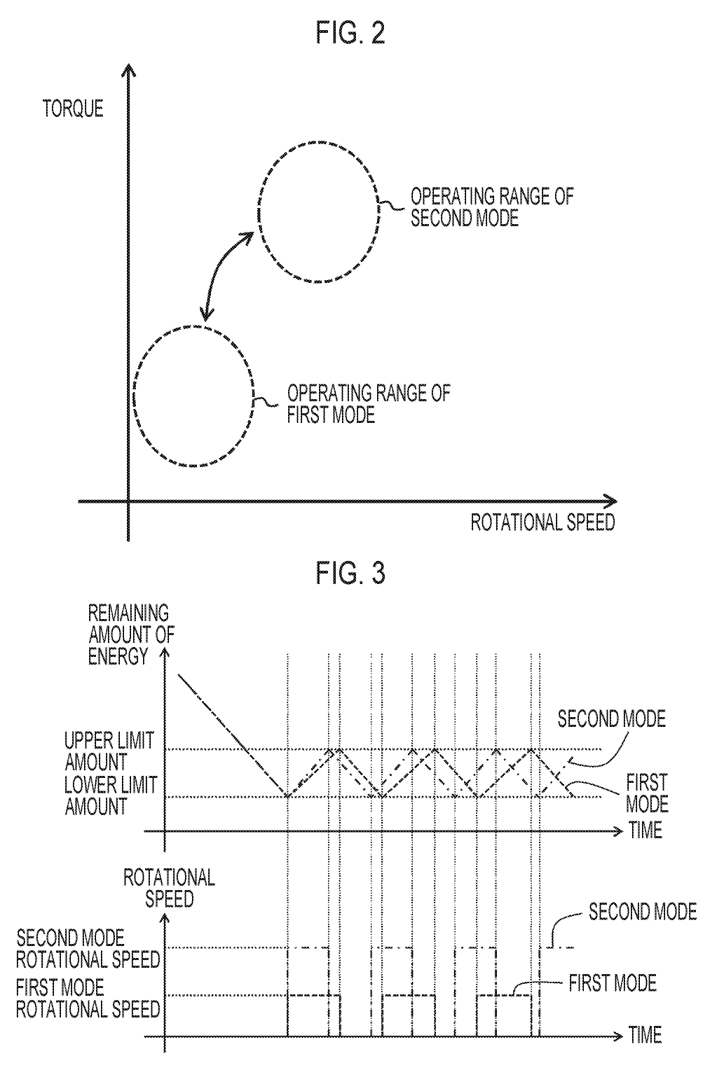

FIG. 2 schematically illustrates an example of the drive conditions of the engine 10 (internal combustion engine) in the first mode M1 and the second mode M2. A horizontal axis of the graph of FIG. 2 corresponds to the rotational speed of the engine 10, and a vertical axis corresponds to the torque of the engine 10. The torque of the engine 10 may be measured as appropriate. For example, the rotational speed of the motor 30 may be measured by the encoder. The torque of the engine 10 may be calculated based on the measured rotational speed of the motor 30 and the gear ratio. As an example, in the first mode M1 and the second mode M2, an operating range of at least one of the rotational speed and the torque of the engine 10 may be defined as the output of the engine 10. As the rotational speed of the engine 10 increases, the torque of the engine 10 also increases. As a result, the power supply efficiency is improved. A range having good power supply efficiency (a range in which the power supply efficiency exceeds a predetermined value) is present in a region in which the rotational speed of the engine 10 is high and the torque is high. The drive conditions of the second mode M2 may be set to the range having good power supply efficiency. The good power supply efficiency may be that the amount of charging of the battery (battery 40) is large when the internal combustion engine (engine 10) is driven by consuming a predetermined amount of fuel. The power supply efficiency may be referred to as "fuel efficiency". On the other hand, the drive conditions of the first mode M1 may be set based on a noise level generated by driving the engine 10. For example, the drive conditions of the first mode M1 may be set in a range in which the noise level is equal to or less than a defined value. Defining the output of the engine 10 to be higher than in the first mode M1 may be defining the drive conditions of the second mode M2 such that an upper limit value of the output of the engine 10 in the second mode M2 is higher than an upper limit value of the output of the engine 10 in the first mode M1. The output of the engine 10 is the rotational speed, the torque, and the like. When the condition is satisfied, the operating range of the output in the first mode M1 may partially overlap with the operating range of the output in the second mode M2, or may not overlap with the operating range of the output in the second mode M2.

In the second mode M2, the output of the engine 10 when the engine 10 is driven is defined to be higher than in the first mode M1, so that the quietness deteriorates as compared with the first mode M1, but the power supply efficiency can be improved. On the other hand, in the first mode M1, the power supply efficiency deteriorates as compared with the second mode M2, but the quietness can be secured. Therefore, according to the present embodiment, by switching the drive mode DM between the first mode M1 and the second mode M2, it is possible to execute charging of the battery 40 during the external power supply by switching between prioritizing quietness and prioritizing power supply efficiency. The first mode M1 may be referred to as a quietness-priority mode, and the second mode M2 may be referred to as a power supply efficiency-priority mode. The modes PM may solely include the first mode M1 and the second mode M2, or may further include one or more other modes in addition to the first mode M1 and the second mode M2. Any of the one or more other modes may be selected as the drive mode DM. In addition, the lower limit amount that serves as a criterion for starting charging of the battery 40 by driving the engine 10 may be the same in each of the modes PM, or may differ in at least some of the modes. The lower limit amount may be the same or different between the first mode M1 and the second mode M2.

### Control Device/End of Battery Charging

Returning to FIG. 1, the charging of the battery 40 by driving the engine 10 may be ended at any timing. In one example, the control device 60 may be configured to further execute monitoring the remaining amount of energy of the battery 40 while the charging continues after the charging of the battery 40 by driving the engine 10 is started. Further, the control device 60 may be configured to further execute ending the charging of the battery 40 by stopping the driving of the engine 10, in accordance with a result of the monitoring indicating that the remaining amount of energy of the battery 40 has reached an upper limit amount. In one example, as in the situation described above, the control device 60 may continuously monitor the remaining amount of energy of the battery 40 via the control unit 45. The control device 60 may determine whether the remaining amount of energy of the battery 40 has reached the upper limit amount in accordance with the result of the monitoring. The upper limit amount (upper limit threshold value) may be optionally defined. When the acquired remaining amount of energy is less than the upper limit amount, the control device 60 may determine that the remaining amount of energy has not reached the upper limit amount. On the other hand, when the acquired remaining amount of energy exceeds the upper limit amount, the control device 60 may determine that the remaining amount of energy has reached the upper limit amount. When the acquired remaining amount of energy is equal to the upper limit amount, the control device 60 may determine that the remaining amount of energy has reached the upper limit amount or may determine that the remaining amount of energy has not reached the upper limit amount. The control device 60 may end charging of the battery 40 by driving the engine 10 by providing the control signal to each of the control units (11, 32) in response to the determination that the remaining amount of energy of the battery 40 has reached the upper limit amount.

The upper limit amount that serves as a criterion for ending the charging may be the same in each of the modes PM, or may be different in at least some of the modes. The upper limit amount may be the same or different between the first mode M1 and the second mode M2. In one example, the upper limit amount may be defined in at least some of the modes PM. At least some of the modes PM in which the upper limit amount is defined may include at least one of the first mode M1 and the second mode M2. The upper limit amount may not be defined in at least some of the modes PM. In the mode in which the upper limit amount is not defined, a predetermined value (predetermined amount) may be used as the upper limit amount. In one example, the second mode M2 may be defined such that the upper limit amount when the charging of the battery 40 is ended is higher than in the first mode M1. That is, the upper limit amount of the second mode M2 may be defined to be higher than the upper limit amount of the first mode M1.

### Control Device/Remaining Amount of Energy of Battery During External Power Supply

FIG. 3 schematically illustrates an example of a relationship between the driving (rotational speed) of the engine 10 and the remaining amount of energy of the battery 40 in each of the modes (M1, M2). In the example of FIG. 3, a situation is assumed in which the upper limit amount of the second mode M2 is the same as that of the first mode M1, the external power supply is continuously executed, and the discharge (external power supply) of the battery 40 during the period in which the engine 10 is not driven is constant. In this situation, in the second mode M2, the output of the engine 10 is higher and the power supply efficiency is better than those in the first mode M1. Therefore, in the second mode M2, the remaining amount of energy of the battery 40 reaches the upper limit amount faster than in the first mode M1. As a result, the driving time of the engine 10 is shortened. From this point as well, it is possible to expect improvement in the power supply efficiency.

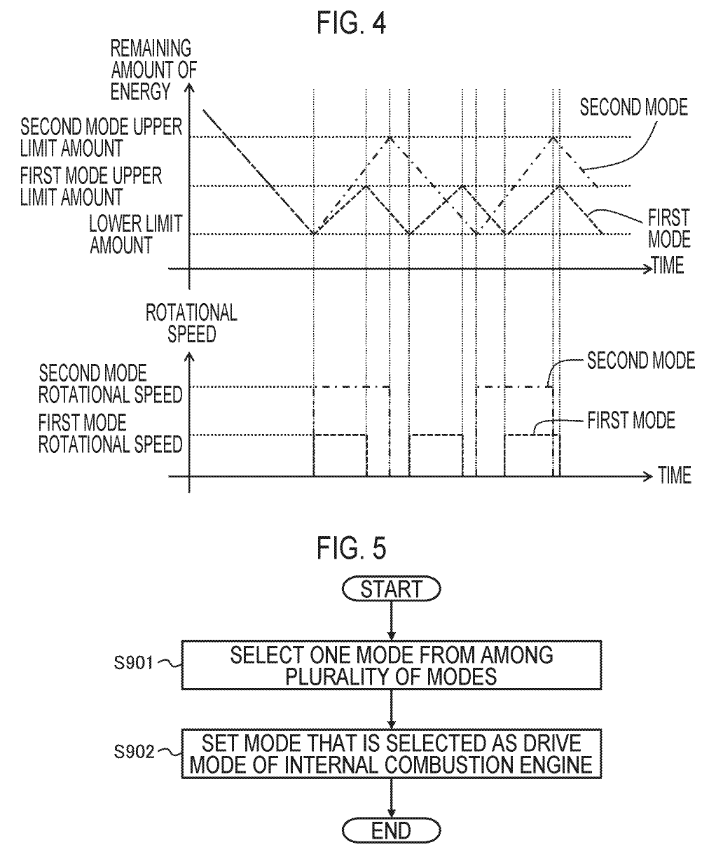

FIG. 4 illustrates a case where the upper limit amount of the second mode M2 is defined to be higher than the upper limit amount of the first mode M1. FIG. 4 schematically illustrates another example of a relationship between the driving (rotational speed) of the engine 10 and the remaining amount of energy of the battery 40 in each of the modes (M1, M2). Other points are the same as in the example of FIG. 3. In this case, in the second mode M2, the upper limit amount is defined to be higher than in the first mode M1, so that the driving time of the engine 10 in a state of good power supply efficiency is longer than in the example of FIG. 3. In addition, in the second mode M2, the upper limit amount is defined to be high, so that the number of repetitions of the driving and the stopping of the engine 10 can be suppressed. Since the engine 10 may consume an extra amount of fuel when driven, the power supply efficiency can be improved by suppressing the number of repetitions of the driving and the stopping of the engine 10. For these reasons, in the second mode M2, the upper limit amount is defined to be higher than in the first mode M1, so that it is possible to expect further improvement in the power supply efficiency. A difference between the upper limit amount of the second mode M2 and the upper limit amount of the first mode M1, when the upper limit amount of the second mode M2 is defined to be higher than the upper limit amount of the first mode M1, may not be particularly limited and may be defined as appropriate according to the embodiment.

### Control Device/Selection Method

Returning to FIG. 1, a method of selecting one mode from among the modes PM may not be particularly limited and may be selected as appropriate according to the embodiment. In one example of the present embodiment, the control device 60 may be configured to select one mode from among the modes PM by at least any one of the following four methods.

In the first method, selecting one mode may include receiving the instruction from the user Z1 and selecting one mode from among the modes PM in response to the instruction from the user Z1. That is, the mode corresponding to the instruction from the user Z1 may be selected as the drive mode DM. The instruction from the user Z1 may be received by any method. In the example, the control device 60 may receive the instruction from the user Z1 via the input device (the touch panel 75, the operator 76, or the like). In another example, the control device 60 may be configured to receive data of a remote operation from the user terminal U1. The control device 60 may be directly or indirectly connected to the user terminal U1. The control device 60 may be connected to the user terminal U1 via an input port or a communication port. The control device 60 may be connected to the user terminal U1 via another control unit, any network, or the like. The control device 60 may receive the instruction from the user Z1 via the remote operation from the user terminal U1.

In the second method, selecting one mode may include receiving a specific operation via the operation device 70 provided in the hybrid electric vehicle V1. Further, selecting one mode may include selecting one mode from among the modes PM in response to the specific operation. That is, the mode corresponding to the executed specific operation may be selected as the drive mode DM. The specific operation may be any operation different from the normal operation of the vehicle (hybrid electric vehicle V1). In one example, the specific operation may include an operation that is not normally executed when the hybrid electric vehicle V1 is powered on, such as setting the operation position of the shift lever to the P position and setting the accelerator operation amount to 100%. When the specific operation is executed while the hybrid electric vehicle V1 is powered on, the control device 60 may set the mode corresponding to the specific operation as the drive mode DM. After being powered on, the control device 60 may operate the external power supply in the drive mode DM that is set. The specific operation corresponding to each of the modes PM (first mode M1 and second mode M2) may not be particularly limited and may be defined as appropriate according to the embodiment. The correspondence relationship between each of the modes PM and the specific operation may be defined as appropriate in a program or the like. The specific operation is preferably an operation that can be executed at once. The specific operation is easily executed. Therefore, according to one example of the present embodiment, it is possible to expect a reduction in the effort when the drive mode DM is set by enabling the selection of each of the modes PM by the specific operation.

In the third method, selecting one mode may include acquiring the position information of the hybrid electric vehicle V1. Further, selecting one mode may include selecting one mode from among the modes PM in accordance with the position information that is acquired. The position information may be acquired by any method. In one example, the hybrid electric vehicle V1 may include a positioning module. The positioning module may be deployed as appropriate in the hybrid electric vehicle V1. For example, the positioning module may be directly deployed in the hybrid electric vehicle V1. In addition, the positioning module may be deployed in equipment such as a navigation device mounted on the hybrid electric vehicle V1. That is, the positioning module may be indirectly deployed in the hybrid electric vehicle V1. The control device 60 may acquire the position information measured by the positioning module via the input port or the communication port. In another example, the user terminal (the user terminal U1 or the like) may include a positioning module. The control device 60 may acquire the position information measured by the positioning module of the user terminal by communicating with the user terminal. As in these examples, the position information of the hybrid electric vehicle V1 may be directly measured by the positioning module deployed in the hybrid electric vehicle V1. Alternatively, the position information of the hybrid electric vehicle V1 may be indirectly measured by a positioning module mounted on a device (user terminal or the like) other than the hybrid electric vehicle V1. The type of the positioning module may not be particularly limited and may be selected as appropriate according to the embodiment. For example, the positioning module may include a global positioning system (GPS) sensor or a global navigation satellite system (GNSS) sensor. The position information may be configured to indicate a current position of the hybrid electric vehicle V1.

A correspondence relationship between the position information and the selected mode may not be particularly limited and may be defined as appropriate according to the embodiment. In one example, in a first region (a residential area or the like) in which the quietness is required, a mode (the first mode M1 or the like) that prioritizes the quietness may be selected. On the other hand, in a second region (a campground or the like) in which the quietness is not required, a mode (the second mode M2 or the like) that prioritizes the power supply efficiency may be selected. The control device 60 may specify as appropriate a region to which the current position of the hybrid electric vehicle V1 indicated by the position information belongs. For example, the control device 60 may specify the region to which the current position of the hybrid electric vehicle V1 indicated by the position information that is acquired belongs by communicating with the navigation device or the user terminal. The region to which the current position belongs may be specified on the control device 60or may be specified on the navigation device or the user terminal. When adopting the latter, acquiring the position information may include acquiring a result of specifying the region to which the current position belongs.

Map information may be used as appropriate to specify the region to which the current position belongs. In one example, each region may be defined in advance in the map information. In this case, the region to which the current position belongs may be specified by comparing the current position with the definitions for each region on the map information. A method of defining each region may not be particularly limited and may be selected as appropriate according to the embodiment. For example, when a region on the map is divided into two regions of the first region and the second region, the second region may be defined as a region other than the first region by defining the first region. On the contrary, the first region may be defined as a region other than the second region by defining the second region. In another example, conditions for each region may be defined for the attributes of a position (road type, location, and the like) defined on map information. The region to which the current position belongs may be specified in accordance with which region's conditions are satisfied by the attribute value of the current position obtained from the map information. The map information may be stored in any storage region and may be referred to as appropriate when the region to which the current position belongs is specified. Any storage region may include, for example, a memory resource of the navigation device or the user terminal, or an external storage device (server device or the like). The control device 60 may select one mode from among the modes PM in accordance with the specified region. For example, the control device 60 may select the first mode M1 in accordance with the current position belonging to the first region, and may select the second mode M2 in accordance with the current position belonging to the second region. According to one example of the present embodiment, it is possible to expect the execution of the external power supply in the mode suitable for the location.

In the fourth method, the hybrid electric vehicle V1 may include the external power supply connectors 55. Selecting one mode may include selecting one mode from among the modes PM in accordance with the external power supply connector 55 that is used for connection with the external device E1 from among the external power supply connectors 55. A correspondence relationship between the external power supply connector 55 and the selected mode may be defined as appropriate according to the embodiment. In one example, the more an external power supply connector 55 that is likely to be connected to an external device E1 having high power consumption is used, the more likely a mode that prioritizes power supply efficiency may be selected. The more the external power supply connector 55 that is likely to be connected to the external device E1 having low electric power consumption is used, the more likely a mode that prioritizes quietness is to be selected. For example, the external power supply connectors 55 may include a first connector provided outside the hybrid electric vehicle V1 (outside the vehicle). In addition, the external power supply connectors 55 may include a second connector provided inside the hybrid electric vehicle V1 (inside the vehicle). Since the first connector is provided outside the vehicle, the first connector is likely to be connected to the external device E1 (facility or the like) having a higher electric power consumption than the second connector. Therefore, when the first connector is used, the control device 60 may select a mode (second mode M2 or the like) that prioritizes the power supply efficiency from among the modes PM. On the other hand, when the second connector is used, the control device 60 may select a mode (first mode M1 or the like) that prioritizes the quietness from among the modes PM. According to one example of the present embodiment, it is possible to expect a reduction in the effort when the drive mode DM is set by selecting the mode in accordance with the external power supply connector 55 to be used.

A method of selecting the mode to be used in accordance with the external device E1 may not be limited to such an example. In another example, when the hybrid electric vehicle V1 includes one external power supply connector 55, selecting one mode may include the following configuration. That is, selecting one mode may include selecting one mode from among the modes PM in accordance with at least any one of the type of the external device E1 and the method of connecting to the external device E1. When the hybrid electric vehicle V1 includes the external power supply connectors 55, selecting one mode may include the following configuration. That is, selecting one mode may include selecting one mode from among the modes PM in accordance with at least any one of the external power supply connector 55 to be used, the type of the external device E1, and the method of connecting to the external device E1. A correspondence relationship between each element and the selected mode may be defined as appropriate according to the embodiment. In one example, the more likely the external device E1 having high electric power consumption is to be connected, the more likely a mode that prioritizes power supply efficiency is to be selected. The more likely the external device E1 having low electric power consumption is to be connected, the more likely a mode that prioritizes quietness is to be selected.

### Type of Hybrid Electric Vehicle

The type of the hybrid electric vehicle V1 may not be particularly limited as long as the internal combustion engine and the battery 40 are included, and may be selected as appropriate according to the embodiment. In one example, the hybrid electric vehicle V1 may include a hybrid electric vehicle (HEV), a plug-in hybrid electric vehicle (PHEV), or the like. An attribute (size, number of wheels, or the like) of the hybrid electric vehicle V1 may not be particularly limited and may be selected as appropriate according to the embodiment. The hybrid electric vehicle V1 may include a manually driven vehicle and an autonomous driving vehicle.

### Operation Example

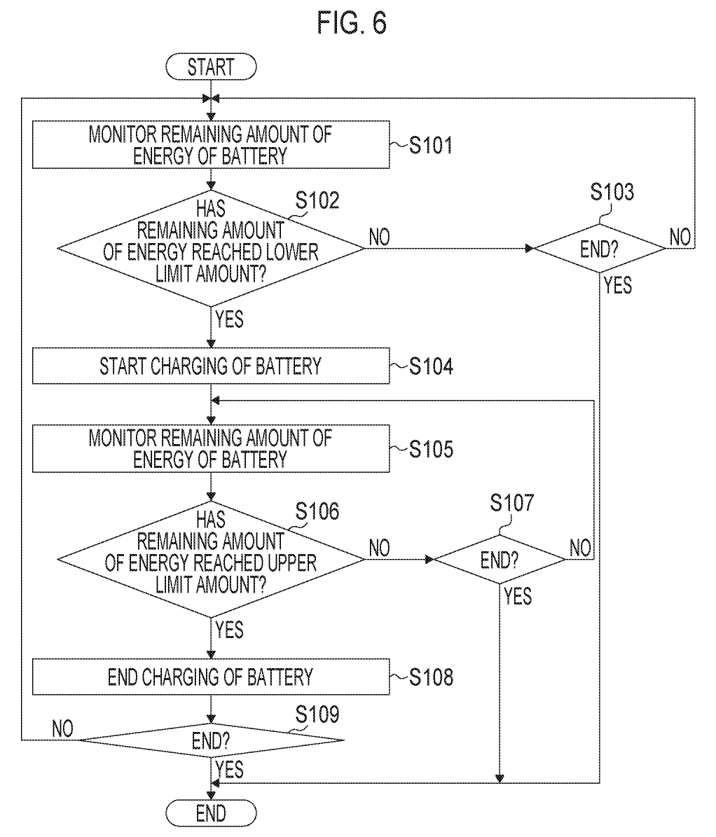

FIG. 5 is a flowchart illustrating an example of a processing procedure related to the mode setting by the control device 60 according to the present embodiment. FIG. 6 is a flowchart illustrating an example of a processing procedure related to the external power supply in the HV power supply mode by the control device 60 according to the present embodiment. The processor 601 of the control device 60 executes a command included in a program stored in the memory 602. As a result, the control device 60 operates as a computer capable of executing the information processing of FIGS. 5 and 6. The following processing procedure is an example of an information processing method executed by a computer (control device 60). However, the following processing procedure is merely an example, and each step may be modified as much as possible. For the following processing procedure, a step can be omitted, replaced, or added as appropriate according to the embodiment. In addition, the following operation of the control device 60 may be interpreted as an operation of the processor 601.

### Mode Setting

The control device 60 may start the execution of the processing procedure related to the mode setting of FIG. 5 at any timing. For example, the control device 60 may start the execution of the processing procedure related to the mode setting of FIG. 5 in response to the operation of the operation device 70, the operation of the input device, and the like.

In S901, the control device 60 selects one mode from among the modes PM. The modes PM include a first mode M1 and a second mode M2. The second mode M2 is defined such that the output of the engine 10 when the engine 10 is driven is higher than in the first mode M1.

A method of selecting the mode may not be particularly limited and may be selected as appropriate according to the embodiment. In one example, the control device 60 may receive the instruction from the user Z1 and select one mode from among the modes PM in response to the instruction from the user Z1. The instruction from the user Z1 may be received via the input device (the touch panel 75, the operator 76, or the like), the user terminal U1, or the like. In another example, the control device 60 may receive the specific operation via the operation device 70 provided in the hybrid electric vehicle V1 and select one mode from among the modes PM in response to the received specific operation. In another example, the control device 60 may acquire the position information of the hybrid electric vehicle V1 and select one mode from among the modes PM in accordance with the acquired position information. For example, when the current position indicated by the position information belongs to the first region in which the quietness is required, the control device 60 may select the first mode M1 as the drive mode DM. When the current position belongs to the second region in which the quietness is not required, the control device 60 may select the second mode M2 as the drive mode DM. In another example, the control device 60 may select one mode from among the modes PM in accordance with the external power supply connector 55 used for connection with the external device E1 from among the external power supply connectors 55. For example, the external power supply connectors 55 may include a first connector provided outside the hybrid electric vehicle V1 and a second connector provided inside the hybrid electric vehicle V1. The control device 60 may select the second mode M2 in accordance with the use of the first connector and may select the first mode M1 in accordance with the use of the second connector. In another example, the control device 60 may select one mode from among the modes PM in accordance with at least any one of the type of the external device E1 and the method of connecting to the external device E1. When one mode is selected, the control device 60 proceeds to the next S902.

In S902, the control device 60 sets the mode that is selected as the drive mode DM of the engine 10. The setting process may be configured as appropriate to set the control device 60 to a state of driving the engine 10 in the mode that is selected during the external power supply in the HV power supply mode. When the setting of the drive mode DM is completed, the control device 60 ends the processing procedure related to the mode setting according to the present operation example.

### Information Processing During External Power Supply

The control device 60 may start the execution of the processing procedure of FIG. 6 at any timing when the external power supply is being executed in the HV power supply mode. In one example, the control device 60 may start the execution of the processing procedure of FIG. 6 along with the start of the execution of the external power supply in the HV power supply mode. The external power supply may be executed at any timing. In one example, the control device 60 may start the execution of the external power supply from the battery 40 to the external device E1 in response to the establishment of a predetermined operating condition. In addition, when the power supply modes are prepared, the power supply mode to be used may be selected as appropriate from among the power supply modes. A selection method of the power supply mode may be the same as the selection method of the drive mode DM described above. When the HV power supply mode is selected, the control device 60 may start the execution of the processing procedure of FIG. 6.

In S101, the control device 60 monitors the remaining amount of energy of the battery 40 while the electric power of the battery 40 is being supplied to the external device E1 via the external power supply connector 55.

In S102, the control device 60 determines whether the remaining amount of energy of the battery 40 has reached the lower limit amount in accordance with the result of the monitoring. The value of the lower limit amount may be stored in the memory 602 (in a program or the like) as appropriate and may be referred to as appropriate when the external power supply is executed. When it is determined that the remaining amount of energy of the battery 40 has not reached the lower limit amount, the control device 60 proceeds to the next S103. On the other hand, when it is determined that the remaining amount of energy of the battery 40 has reached the lower limit amount, the control device 60 proceeds to the next S104.

In S103, the control device 60 determines whether to end the processing. The determination criterion may be optionally set. In one example, the control device 60 may determine not to end the processing until the execution of the external power supply is stopped. On the other hand, when the execution of the external power supply is stopped, the control device 60 may determine to end the processing.

When it is determined not to end the processing, the control device 60 returns to S101 and executes the processing again from S101. As a result, the control device 60 may continuously monitor the remaining amount of energy of the battery 40 while the electric power of the battery 40 is being supplied to the external device E1 via the external power supply connector 55. On the other hand, when it is determined to end the processing, the control device 60 ends the processing procedure related to the external power supply according to the present operation example. The timing at which the processing is ended may not be limited to such an example. The control device 60 may end the execution of the processing procedure related to the external power supply at any timing.

In S104, the control device 60 drives the engine 10, in the drive mode DM that is set to cause the motor 30 to generate the electricity, in accordance with the result of the monitoring indicating that the remaining amount of energy of the battery 40 has reached the lower limit amount. As a result, the control device 60 starts charging of the battery 40. The driving conditions of each of the modes may be stored in the memory 602 (in a program or the like) as appropriate and may be referred to as appropriate when the external power supply is executed. When the first mode M1 is selected as the drive mode DM, the control device 60 executes the charging of the battery 40 by driving the engine 10 in the first mode M1. When the second mode M2 is selected, the control device 60 executes the charging of the battery 40 by driving the engine 10 in the second mode M2. When the charging of the battery 40 is started, the control device 60 proceeds to the next S105.

In S105, the control device 60 monitors the remaining amount of energy of the battery 40 while the charging continues after the charging of the battery 40 is started by driving the engine 10. The processing of S105 may be the same as the processing of S101, except for the presence or absence of the driving of the engine 10.

In S106, the control device 60 determines whether the remaining amount of energy of the battery 40 has reached the upper limit amount in accordance with the result of the monitoring. The value of the upper limit amount may be stored in the memory 602 (in a program or the like) as appropriate and may be referred to as appropriate when the external power supply is executed. In one example, the upper limit amount may be defined in at least some of the modes PM. When the upper limit amount is defined in the mode selected as the drive mode DM, the control device 60 may determine whether the remaining amount of energy of the battery 40 has reached the upper limit amount defined in the drive mode DM that is set. In one example, the upper limit amount of the second mode M2 may be defined to be higher than the upper limit amount of the first mode M1. When it is determined that the remaining amount of energy of the battery 40 has not reached the upper limit amount, the control device 60 proceeds to the next S107. On the other hand, when it is determined that the remaining amount of energy of the battery 40 has reached the upper limit amount, the control device 60 proceeds to the next S108.

In S107, the control device 60 determines whether to end the processing. The processing of S107 may be the same as the processing of S103. When it is determined not to end the processing, the control device 60 returns to S105 and executes the processing again from S105. As a result, the control device 60 may continuously monitor the remaining amount of energy of the battery 40 while the charging continues after the charging of the battery 40 is started by driving the engine 10. On the other hand, when it is determined to end the processing, the control device 60 ends the processing procedure related to the external power supply according to the present operation example.

In S108, the control device 60 ends the charging of the battery 40 by stopping the driving of the engine 10, in accordance with the result of the monitoring indicating that the remaining amount of energy of the battery 40 has reached the upper limit amount. When the charging of the battery 40 is ended, the control device 60 proceeds to the next S109.

In S109, the control device 60 determines whether to end the processing. The processing of S109 may be the same as the processing of S103 or the like. When it is determined not to end the processing, the control device 60 returns to S101 and executes the processing again from S101. On the other hand, when it is determined to end the processing, the control device 60 ends the processing procedure related to the external power supply according to the present operation example. The control device 60 may execute the series of processing of S101 to S109 in real time while executing the external power supply.

### Features

In the present embodiment, the first mode M1 that prioritizes the quietness and the second mode M2 that prioritizes the power supply efficiency are prepared as candidates for the drive mode DM during the external power supply. By the processing of S901, the drive mode DM can be switched between the first mode M1 and the second mode M2. As a result, in the processing of S104, the charging of the battery 40 can be executed during the external power supply by switching between prioritizing quietness and prioritizing power supply efficiency.

### Modification

Although the embodiments of the present disclosure have been described in detail above, the above description is merely an example of the present disclosure in every respect. The processing and means described in the present disclosure can be implemented in any combination as long as no technical inconsistencies arise. In the embodiments described above, various improvements or modifications may be made as appropriate. The configuration of the hybrid electric vehicle V1 may not be limited to the example of FIG. 1 and may be modified as appropriate according to the embodiment. Regarding the specific hardware configuration of the hybrid electric vehicle V1, components can be omitted, replaced, or added as appropriate according to the embodiment.

What is claimed is:

1. A hybrid electric vehicle comprising:
an internal combustion engine;
a generator;
a battery;
an external power supply connector; and
a control device, wherein:
the generator is configured to generate electricity using power from the internal combustion engine;
the battery is connected to the generator via an electric power line;
the external power supply connector is configured to supply electric power of the battery to an external device to be connected;
the control device is configured to execute:
monitoring a remaining amount of energy of the battery while the electric power of the battery is being supplied to the external device via the external power supply connector; and
starting charging of the battery by driving the internal combustion engine in a drive mode that is set to cause the generator to generate the electricity, in response to the remaining amount of the energy of the battery reaching a lower limit amount as a result of the monitoring;
the control device is configured to further execute:
selecting one mode from among a plurality of modes; and
setting the mode that is selected as the drive mode of the internal combustion engine;
the modes include a first mode and a second mode; and
the second mode is defined such that an output of the internal combustion engine when the internal combustion engine is driven is higher than an output of the internal combustion engine in the first mode.

2. The hybrid electric vehicle according to claim 1, wherein:
the control device is configured to further execute:
monitoring the remaining amount of the energy of the battery while the charging continues after the charging of the battery is started; and
ending the charging of the battery by stopping the driving of the internal combustion engine, in response to the remaining amount of the energy of the battery reaching an upper limit amount defined in the drive mode that is set, as a result of the monitoring; and
the second mode is defined such that the upper limit amount when the charging of the battery is ended is higher than the upper limit amount in the first mode.

3. The hybrid electric vehicle according to claim 1, wherein the selecting of the one mode includes:
receiving a specific operation via an operation device provided in the hybrid electric vehicle; and
selecting one mode from among the modes in response to the specific operation.

4. The hybrid electric vehicle according to claim 1, wherein the selecting of the one mode includes:
acquiring position information of the hybrid electric vehicle; and
selecting one mode from among the modes in accordance with the position information that is acquired.

5. The hybrid electric vehicle according to claim 1, further comprising a plurality of the external power supply connectors,
wherein the selecting of the one mode includes selecting one mode from among the modes in accordance with the external power supply connector used for connection with the external device from among the external power supply connectors.
